(19) United States
(12) Patent Application Publication
(10) Pub. No.: US 2006/0147832 A1
(43) Pub. Date: Jul. 6, 2006

(54) Polymer and positive type resist composition

(76) Inventors: Hideo Hada, Kawasaki-shi (JP); Miwa Miyairi, Kawasaki-shi (JP); Takeshi Iwai, Kawasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/547,632

(22) PCT Filed: Feb. 26, 2004
(86) PCT No.: PCT/JP04/02275

§ 371 Date: Sep. 1, 2005

(30) Foreign Application Priority Data
Mar. 4, 2003 (JP) 2003-56975

(51) Int. Cl. G03C 1/76

(52) U.S. Cl. 430/270.1

(57) ABSTRACT

There is provided technology that enables the suppression of the surface roughness that occurs within a resist pattern, either following etching or following developing, or preferably following both processes. According to this technology, a resist pattern is formed using a positive resist composition including a resin component (A), which contains a structural unit (a1) containing a lactone, as represented by a general formula shown below, and exhibits increased alkali solubility under the action of acid, 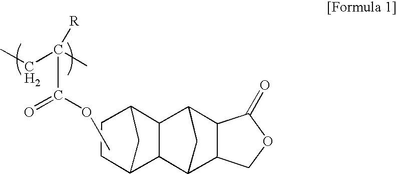 (wherein, R represents a hydrogen atom or a methyl group), an acid generator component (B) that generates acid on exposure, and an organic solvent (C).

### TECHNICAL FIELD

The present invention relates to a polymer that can be used favorably within a positive resist composition, a positive resist composition that uses the polymer, and a method of forming a resist pattern that uses the positive resist composition.

### BACKGROUND ART

In recent years, the miniaturization of semiconductor elements has continued to progress, and the development of processes using ArF excimer lasers (193 nm) and the like is being vigorously pursued. As the base resin for chemically amplified resists for use with ArF excimer lasers, resins that exhibit a high level of transparency relative to the ArF excimer laser are preferred.

For example, resins in which the principal chain contains structural units derived from a (meth)acrylate ester containing a polycyclic hydrocarbon group such as an adamantane skeleton at the ester section are attracting considerable attention, and many such resins have already been proposed (see the patent references 1 to 11 listed below).

Furthermore, of these, the patent references 8 to 11, in particular, propose polymers containing a specific lactone structure on a resin side chain, as well as the monomers for producing such polymers,

[Patent Reference 1]

Japanese Patent (Granted) Publication No. 2,881,969

[Patent Reference 2]

Japanese Unexamined Patent Application, First Publication No. Hei 5-346668

[Patent Reference 3]

Japanese Unexamined Patent Application, First Publication No. Hei 7-234511

[Patent Reference 4]

Japanese Unexamined Patent Application, First Publication No. Hei 9-73173

[Patent Reference 5]

Japanese Unexamined Patent Application, First Publication No. Hei 9-90637

[Patent Reference 6]

Japanese Unexamined Patent Application, First Publication No. Hei 10-161313

[Patent Reference 7]

Japanese Unexamined Patent Application, First Publication No. Hei 10-319595

[Patent Reference 8]

Japanese Unexamined Patent Application, First Publication No. He! 11-12326

[Patent Reference 9]

Japanese Unexamined Patent Application, First Publication No. Hei 2000-26446

[Patent Reference 10]

Japanese Unexamined Patent Application, First Publication No. Hei 2002-371114

[Patent Reference 11]

Japanese Unexamined Patent Application, First Publication No, Hei 2002-308866

However, in recent years, because of the development of different etching films for use on semiconductor substrates, a variety of etching gases are now able to be used. As a result, a new problem has arisen in that surface roughness appears on the resist film following etching.

This surface roughness is different from conventional dry etching resistance, and in a film etched using a resist pattern as a mask, appears as distortions around the hole patterns in a contact hole pattern, or as line edge roughness in a line and space pattern. Line edge roughness refers to non-uniform irregularities in the line side walls.

Furthermore, in addition to this type of surface roughness, line edge roughness also occurs in the resist pattern following developing.

If this line edge roughness occurs in the resist pattern following developing, then it appears as distortions around the hole patterns in a hole resist pattern, or as non-uniform irregularities in the side walls in a line and space pattern However, resist compositions using conventional resins such as those described above are unable to suppress this type of surface roughness, including line edge roughness, meaning further improvements have been keenly sought

### DISCLOSURE OF INVENTION

The present invention takes the above circumstances into consideration, with an object of enabling the suppression of the surface roughness that occurs within a resist pattern, either following etching or following developing, or preferably following both processes.

A first aspect of the present invention for achieving this object is a polymer containing a structural unit (al) that contains a lactone, as represented by a general formula shown below: 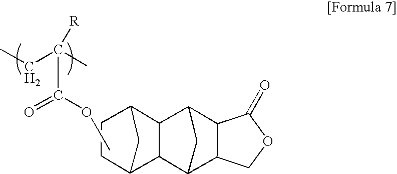
(wherein, R represents a hydrogen atom or a methyl group).

A second aspect is a polymer according to the first aspect, wherein the structural unit (a1) accounts for 20 to 60 mol % of the combined total of all the structural units.

A third aspect is a polymer according to either one of the first and second aspects, further containing a structural unit (a2), which contains an acid dissociable, dissolution inhibiting group, and is derived from a (meth)acrylate ester.

A fourth aspect is a polymer according to the third aspect, wherein the structural unit (a2) is at least one unit selected from a group consisting of the general formulas (I), (II), and (IU) shown below: 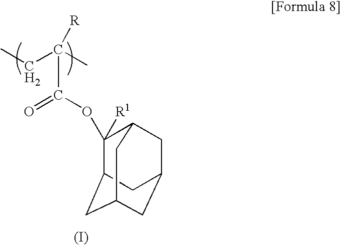
(wherein, R represents a hydrogen atom or a methyl group, and R¹ represents a lower alkyl group) 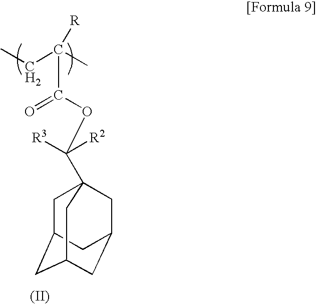
(wherein, R represents a hydrogen atom or a methyl group, and R² and R³ each represent, independently, a lower alkyl group) 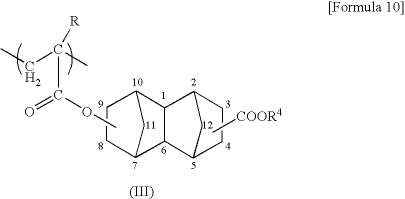
(wherein, R represents a hydrogen atom or a methyl group, and R⁴ represents a tertiary alkyl group).

A fifth aspect is a polymer according to either one of the third and fourth aspects, wherein the structural unit (a2) accounts for 20 to 60 mol % of the combined total of all the structural units.

A sixth aspect is a polymer according to any one of the first through fifth aspects, further containing a structural unit (a3), which contains a hydroxyl group, and is derived from a (meth)acrylate ester.

A seventh aspect is a polymer according to the sixth aspect, wherein the structural unit (a3) is one or two units selected from a group consisting of the general formulas (I) and (V) shown below: 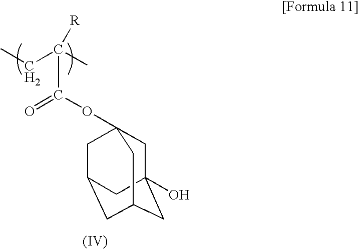
(wherein, R represents a hydrogen atom or a methyl group) 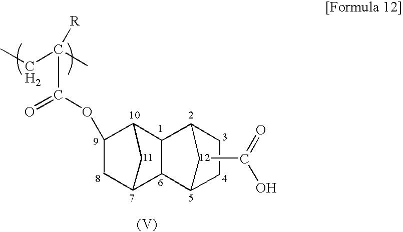
(wherein, R represents a hydrogen atom or a methyl group).

An eighth aspect is a polymer according to either one of the sixth and seventh aspects, wherein the structural unit (a3) accounts for 5 to 50 mol % of the combined total of all the structural units.

A ninth aspect is a polymer of the present invention according to any one of the first through eighth aspects, wherein the polymer is a positive resist composition, and exhibits increased alkali solubility under the action of acid.

A tenth aspect is a positive resist composition including a resin component (A), an acid generator component (B) that generates acid on exposure, and an organic solvent (C), wherein the component (A) is formed from a polymer according to the ninth aspect.

An eleventh aspect is a positive resist composition according to the tenth aspect, wherein the component (B) is an onium salt with a fluorinated alkylsulfonate ion as the anion.

A twelfth aspect is a positive resist composition according to either one of the tenth and eleventh aspects, wherein the component (C) is a mixed solvent of propylene glycol monomethyl ether acetate and a polar solvent.

A thirteenth aspect is a positive resist composition according to the twelfth aspect, wherein the polar solvent is ethyl lactate.

A fourteenth aspect is a positive resist composition according to any one of the tenth through thirteenth aspects, further containing a secondary or tertiary lower aliphatic amine (a).

A fifteenth aspect is a method of forming a resist pattern (a production method) including the steps of applying a positive resist composition according to any one of the tent through fourteenth aspects to a substrate, conducting a prebake, performing selective exposure, conducting PEB (post exposure baking), and performing alkali developing to form a resist pattern.

### BEST MODE FOR CARRYING OUT THE INVENTION

As follows is a detailed description of embodiments of the present invention, using a series of examples.

[Lactone Compound]

As the monomer corresponding with a structural unit (a1) according to the present invention, a lactone compound represented by the general formula shown below can be used favorably. 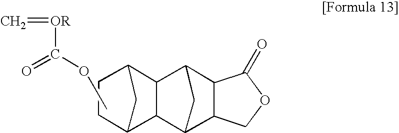
(wherein, R represents a hydrogen atom or a methyl group)

An example of a method of synthesizing the lactone compound represented by the following formula (3) is shown below. 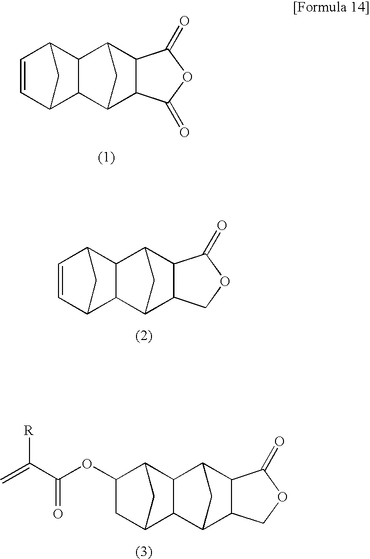
(wherein, R represents a hydrogen atom or a methyl group)

The lactone compound represented by the above formula (3) is an alicyclic lactone (meth)acrylate, and in order to synthesize this compound, an alicyclic alkenyldicarboxylic anhydride represented by the formula (1) is normally used as a starting material. The production method for this starting material typically involves a Diels-Alder reaction between a diene compound such as cyclopentadiene or dicyclopentadiene, and a dienophile compound such as maleic anhydride or norbornene dicarboxylic anhydride. The alicyclic alkenyldicarboxylic anhydride represented by the formula (1) is obtained as a mixture of a variety of different Diels-Alder adducts (for example, in the case of a reaction between cyclopentadiene and maleic anhydride, 1:1 adducts, 2:1 adducts, and 3:1 adducts of the starting materials), but it is well known that by appropriate selection of the molar ratio between the diene compound and the dienophile compound, and the reaction conditions, the yield and selectivity for the target compound can be improved. Furthermore, the targeted alicyclic alkenyldicarboxylic anhydride can be isolated easily from the reaction product mixture using normal separation and purification methods such as distillation under reduced pressure.

First is a description of the conversion from the formula (1) to the formula (2). The compound of the formula (2) can be produced by reducing the compound of the formula (1). Reduction of the alicyclic alkenyldicarboxylic anhydride represented by the formula (1) can be conducted, for example, using the metal hydride compounds disclosed in Canadian Journal of Chemistry; M. Kayser and P. Morand, vol. 56, p. 1524 (1978). For example, sodium borohydride or a modified compound thereof in which a portion of the hydrogen atoms have been substituted with alcoholates, or lithium aluminum hydride or a modified compound thereof in which a portion of the hydrogen atoms have been substituted with alcoholates, can be used. The reduction reaction is preferably conducted within an ether-based solvent such as diectyl ether or tetrahydrofuran. The reducing agent is preferably used in either a stoichiometric quantity or in excess, and the reaction temperature is preferably controlled within a range from −20 to −100° C. Following completion of the reaction, acid is added, and following decomposition of the reducing agent and any oxidation products thereof, the reaction product is extracted and washed with water, and the target compound can then be isolated easily from the reaction product mixture using normal separation and purification methods such as distillation under reduced pressure.

Next is a description of the conversion from the formula (2) to the formula (3). The alicyclic lactone (meth)acrylate represented by the formula (3) is produced by hydrating and then esterifying the olefin portion of the alicyclic alkenyllactone represented by the formula (2). Hydration of the olefin can be conducted using a typical method using an acid catalyst such as sulfuric acid. This hydration reaction involves reacting the alicyclic alkenyllactone represented by the formula (2) in a water-based solvent in the presence of an acid catalyst, for 2 to 10 hours at a temperature of 50 to 110° C. Examples of effective acid catalysts other than sulfuric acid include trifluoroacetic acid and formic acid. The quantity used of the acid catalyst is typically within a range from 0.5 to 1 mol per 1 mol of the olefin.

Following completion of the reaction, the reaction product is extracted into an organic solvent such as ethyl acetate, dried, and then concentrated, yielding an alcohol that functions as a reaction intermediate. Esterification of this alcohol can be achieved easily using known methods. In one suitable method, the prepared alcohol is reacted with either a stoichiometric quantity or an excess of a (meth)acryloyl halide ((meth)acryloyl chloride or (meth)acryloyl bromide) in the presence of an appropriately selected base. A solvent is not essential, although in a preferred reaction, the starting material alcohol, the (meth)acryloyl halide, and a base such as triethylamine are added sequentially or simultaneously to a solvent such as methylene chloride or methyl isobutyl ketone, and cooling is conducted as necessary. Following completion of the reaction, the reaction mixture is neutralized with an acid such as dilute hydrochloric acid, dried, and then concentrated, yielding the alicyclic lactone (meth)acrylate represented by the formula (3). The thus obtained target product can be purified by normal purification methods such as column chromatography.

When this lactone compound (alicyclic lactone (meth)acrylate) is used as a monomer for either the resin of a resist composition or a dissolution inhibitor, surface roughness within the resist pattern, either following etching or following developing, or preferably following both processes, can be improved. It is surmised that this observation is due to an interaction between the effect of the lactone functional group, the effect of the tetracyclo ring, and the effect of the position at which the lactone is bonded to the tetracyclo ring.

[Polymer]

Structural Unit (a1)

As described above, the aforementioned lactone compound is used, for example, as a monomer for forming the polymer that constitutes the resin component of the positive resist composition (although this is not a restrictive use). In other words, a polymer containing a unit derived by cleavage of the ethylenic double bond of the lactone compound is used as the resin component of the positive resist composition.

This unit is represented by the general formula shown above in [formula 7] (and is hereafter referred to as the structural unit (a1)). In the above formula, if R is a hydrogen atom then an acrylate structural unit is formed, whereas if R is a methyl group, a methacrylate structural unit is formed.

A polymer of the present invention contains a structural unit (a1) represented by the above [formula 71. Of the possible structural units (a1), the polymer preferably incorporates an acrylate structural unit and/or a methacrylate structural unit.

The structural unit (a1) typically accounts for 20 to 60 mol %, and preferably from 30 to 50 mol %, of the combined total of all the structural units that constitute the polymer. By ensuring the quantity exceeds the lower limit of the above range, the surface roughness suppression effect can be improved when the polymer is used in a positive resist composition If the quantity exceeds the upper limit of the above range, then when used in a positive resist composition, it becomes impossible to incorporate an adequate quantity of other structural units, such as the structural unit (hereafter referred to as the unit (a2)) that imparts increased alkali solubility in the presence of acid, and there is also a danger of a deterioration in the solubility of the polymer in the resist solvent.

When a positive resist composition is formed, the lactone functional groups are effective in improving the adhesion between the resist film and the substrate, and increasing the hydrophilicity relative to the developing solution.

Furthermore, polymers containing a structural unit (a1) tend to exhibit higher glass transition temperatures than polymers containing structural units with other lactone functional groups. As a result, if a positive resist composition is formed using a component (A) formed from this polymer, then in the process for forming a resist pattern using the composition, which is described below, the heating temperatures can be set to higher values during the PAB and PEB heating treatments, enabling the sensitivity of the positive resist composition to be improved.

Furthermore, it is thought that the presence of the tetracyclo ring improves the surface roughness following etching.

Furthermore, as a result of the position at which the lactone is bonded to the tetracyclo ring, the hydrophilicity of the polymer is increased beyond that observed for conventional polymers containing lactone units, and it is surmised that this causes an improvement in the surface roughness of the resist pattern following developing.

When used within a positive resist composition, in addition to the unit (a1) described above, the polymer preferably also contains a structural unit containing an acid dissociable, dissolution inhibiting group, so that under the action of acid generated from the acid generator component (the component (B)) on exposure, the acid dissociable, dissolution inhibiting group dissociates, causing the entire polymer to change from an alkali insoluble state to an alkali soluble state. As a result, when the composition is exposed through a mask during resist pattern formation, the alkali solubility of the exposed portions increases, enabling alkali developing to be conducted.

Accordingly, when used within a positive resist composition, the polymer is preferably a copolymer that also contains the type of structural unit described below.

Structural Unit (a2)

When used as a positive resist composition, in addition to the unit (a1) described above, the polymer preferably also contains a structural unit containing an acid dissociable, dissolution inhibiting group. There are no particular restrictions on this structural unit containing the acid dissociable, dissolution inhibiting group, provided it is capable of copolymerization with the structural unit (a1) that represents the essential component of the polymer, although from the viewpoints of factors such as the copolymerizability with the structural unit (a1) and the transparency of the polymer relative to the exposure light, a structural unit (a2) which contains an acid dissociable, dissolution inhibiting group, and is derived from a (meth)acrylate ester is preferred. The term (meth)acrylate ester refers to either one of, or both, methacrylate ester and acrylate ester.

When used in a positive resist composition, the acid dissociable, dissolution inhibiting group can use any group, without any particular restrictions, which has an alkali solubility inhibiting effect that renders the entire polymer insoluble in alkali prior to exposure, but then dissociates under the action of acid generated from the component (B) following exposure, causing the entire polymer to become alkali soluble.

Typically, groups that form a cyclic or chain-like tertiary alkyl ester with the carboxyl group of the (meth)acrylic acid are the most widely known, Furthermore, from the viewpoints of achieving favorable polymer transparency and dry etching resistance, an acid dissociable, dissolution inhibiting group that contains an aliphatic polycyclic group is preferred. These polycyclic group-containing acid dissociable, dissolution inhibiting groups are ideal for positive resist compositions for use with shorter wavelengths than KrF and ArF excimer lasers.

Examples of this aliphatic polycyclic group include groups in which in which one hydrogen atom has been removed from a bicycloalkane, tricycloalkane or tetracycloalkane or the like.

Specific examples include groups in which one hydrogen atom has bean removed from a polycycloalkane such as adamantane, norbornane, isobornane, tricyclodecane or tetracyclododecane.

These types of aliphatic polycyclic groups can be appropriately selected from the multitude of groups proposed for polymers (resin components) for use within ArF excimer laser resist compositions.

Of these aliphatic polycyclic groups, adamantyl groups, norbornyl groups and tetracyclododecanyl groups are preferred from an industrial viewpoint Specifically, the structural unit (a2) is preferably at least one unit selected from the groups represented by the general formulas (I), (II), and (III). 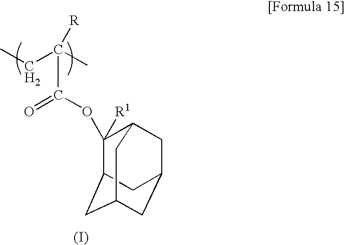
(wherein, R represents a hydrogen atom or a methyl group, and R¹ represents a lower alkyl group) 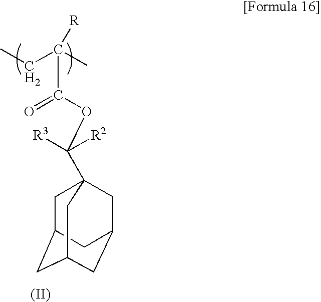
(wherein, R represents a hydrogen atom or a methyl group, R² and R³each represent, independently, a lower alkyl group) 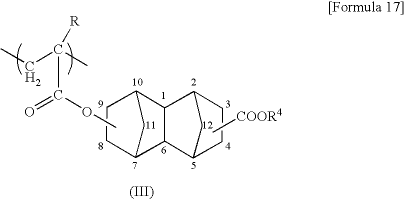
(wherein, R represents a hydrogen atom or a methyl group, and R⁴ represents a tertiary alkyl group).

The structural unit represented by the general formula (I) is a (meth)acrylate structural unit with a hydrocarbon group bonded through an ester linkage, and by bonding a straight chain or a branched alkyl group to the carbon atom of the adamantyl group that is adjacent to the oxygen atom (—O—) of the ester function of the (meth)acrylate structural unit, a tertiary alkyl group is formed within the ring skeleton of the adamantyl group.

In this formula, the group R¹ is preferably a straight chain or branched lower alkyl group of 1 to 5 carbon atoms, and specific examples include a methyl group, ethyl group, propyl group, isopropyl group, n-butyl group, isobutyl group, tert-butyl group, pentyl group, isopentyl group and neopentyl group. Of these, an alkyl group of at least 2 carbon atoms, and preferably from 2 to 5 carbon atoms is preferred, and in such cases, the acid dissociability tends to increase compared with the case in which R¹ is a methyl group. From an industrial viewpoint, a methyl group or ethyl group is preferred.

The structural unit represented by the aforementioned general formula (II), like that of the general formula (I), is a (meth)acrylate structural unit with a hydrocarbon group bonded through an ester linkage, although in this case, the carbon atom adjacent to the oxygen atom (—O—) of the ester function of the (meth)acrylate structural unit is a tertiary alkyl group, and a ring skeleton such as an adamantyl group exists within this tertiary alkyl group.

The groups R² and R³ each preferably represent, independently, a lower alkyl group of 1 to 5 carbon atoms. These types of groups tend to display a higher acid dissociability than a 2-methyl-2-adamantyl group.

Specifically, the groups R² and R³ each represent, independently, the same types of straight chain or branched lower all groups described above for R¹. Of these groups, the case in which R² and R³ are both methyl groups is preferred from an industrial viewpoint.

In the structural unit represented by the aforementioned general formula (III), the carbon atom adjacent to the oxygen atom (—O—) of a separate ester from the ester of the (meth)acrylate structural unit is a tertiary alkyl group, and the (meth)acrylate ester structural unit and this separate ester are connected via a ring skeleton such as a tetracyclododecanyl group.

In this formula, the group R⁴ represents a tertiary alkyl group such as a tert-butyl group or tert-amyl group, although the case in which R⁴ is tert-butyl group is preferred industrially.

Furthermore, the group —COOR⁴ may be bonded to either position 3 or 4 of the tetracyclododecanyl group shown in the formula, although a mixture of both stereoisomers results, and so the bonding position cannot be further specified. Furthermore, the carboxyl group residue of the (meth)acrylate structural unit may be bonded to either position 9 or 10 of the tetracyclododecanyl group, although similarly, a mixture of both stereoisomers results, and so the bonding position cannot be flier specified.

Of the units described above, as the structural unit (a2), the use of either a unit represented by one of the general formulas (I) or (II), or units represented by both general formulas, is preferred, and the use of a structural unit represented by the general formula (I) is particularly desirable. If a structural unit represented by the general formula (I) is used, R¹ is preferably a methyl group or an ethyl group. If a structural unit represented by the general formula (II) is used, the case in which R² and R³ are both methyl groups provides superior resolution, and is consequently preferred.

The structural unit (a2) typically accounts for 20 to 60 mol %, and preferably from 30 to 50 mol %, of the combined total of all the structural units that constitute the polymer. By ensuring the quantity exceeds the lower limit of the above range, a superior level of resolution can be achieved when the polymer is used in a positive resist composition. If the quantity exceeds the upper limit of the above range, then there is a danger that it may become impossible to incorporate an adequate quantity of the other structural units.

Structural Unit (a3)

When used as a positive resist composition, in addition to the units (a1) and (a2) described above, the polymer may also contain a structural unit (a3), which contains a hydroxyl group-containing polycyclic group, and is derived from a (meth)acrylate ester. Because this unit (a3) contains a hydroxyl group, it improves the affinity between the entire polymer and the alkali developing solution used during formation of a resist pattern. Consequently, when the polymer is used within a positive resist composition, the alkali solubility of the exposed portions improves, which contributes to favorable improvements in the resolution and resist pattern shape.

The structural unit (a3) can be appropriately selected from the multitude of structural units proposed for resins for use within ArF excimer laser resist compositions.

The aforementioned polycyclic group can be appropriately selected from the same multitude of aliphatic polycyclic groups described above in relation to the structural unit (a2).

Specifically, as the structural unit (a3), hydroxyl group-containing adamantyl groups (in which the number of hydroxyl groups is preferably from 1 to 3, and most preferably 1), or carboxyl group-containing tetracyclododecanyl groups (in which the number of carboxyl groups is preferably from 1 to 3, and most preferably 1) can be favorably used.

Even more specifically, using a structural unit represented by a general formula (IV) shown below increases the dry etching resistance and improves the verticalness of the cross-sectional shape of the resist pattern when the polymer is used within a positive resist composition, and is consequently preferred.

Furthermore, using a structural unit represented by a general formula (V) shown below also increases the dry etching resistance and improves the verticalness of the cross-sectional shape of the resist pattern when the polymer is used within a positive resist composition, and is consequently preferred. 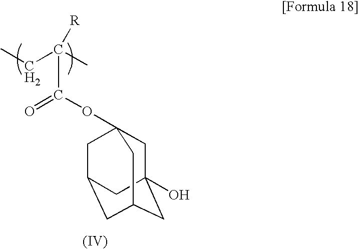
(wherein, R represents a hydrogen atom or a methyl group) 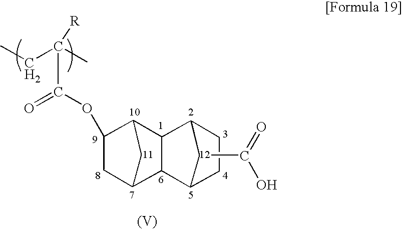
(wherein, R represents a hydrogen atom or a methyl group).

In the general formula (V), the group —COOH may be bonded to the carbon atom at either position 3 or 4 of the tetracyclododecanyl group shown in the formula, although a mixture of both stereoisomers results, and so the bonding position cannot be further specified. Furthermore, the carboxyl group residue of the (meth)acrylate structural unit may be bonded to either position 9 or 10 of the tetracyclododecanyl group, although similarly, a mixture of both stereoisomers results, and so the bonding position cannot be further specified.

The structural unit (a3) typically accounts for 5 to 50 mol %, and preferably from 10 to 40 mol %, of the combined total of all the structural units that constitute the polymer. By ensuring the quantity exceeds the lower limit of the above range, the improvement in the resolution becomes more significant. If the quantity exceeds the upper limit of the above range, then there is a danger that it may become impossible to incorporate an adequate quantity of the other structural units.

Other Structural Units

In addition to the structural units (a1) to (a3), this polymer may also include other structural units.

Examples of these other structural units include conventional lactone-containing structural units (a4) different from the structural unit (a1), and other structural units (a5) different from the structural units (a1) through (a4).

Structural Unit (a4)

As described above, when a positive resist composition is formed, lactone functional groups are effective in improving the adhesion between the resist film and the substrate, and increasing the hydrophilicity relative to the developing solution, and in order to maximize these effects, a lactone-containing structural unit (a4) that is different from the structural unit (a1) can also be used.

Structural units which contain a lactone-containing monocyclic or polycyclic group, and are also derived from a (meth)arylate ester, are preferred.

Examples of lactone-containing monocyclic groups include groups in which one hydrogen atom has been removed from y-butyrolactone.

Examples of lactone-containing polycyclic groups include groups in which one hydrogen atom has been removed from the lactone-containing polycycloalkanes of the structural formulas shown below.

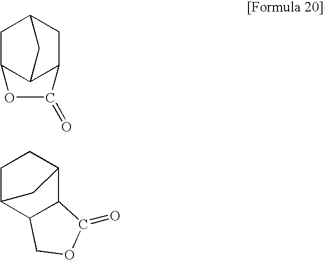

In addition, the lactone-containing monocyclic or polycyclic group is preferably one or more groups selected from the general formulas shown below.

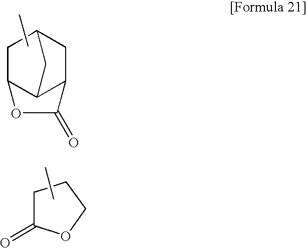

More specifically, structural units derived from a (meth)acrylate ester containing a lactone-containing monocycloalkyl group or bicycloalkyl group, as represented by the structural formulas shown below, are particularly preferred. 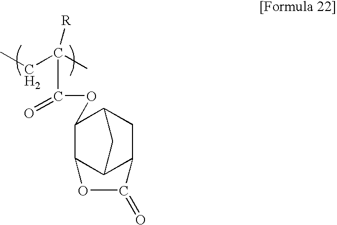
(wherein, R is as defined above) 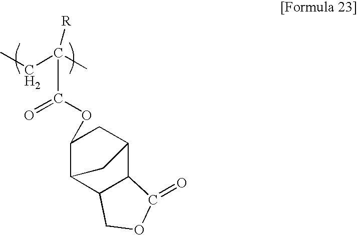
(wherein, R is as defined above) 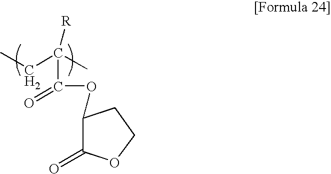
(wherein, R is as defined above)

Of these units, γ-butyrolactone esters of (meth)acrylic acid with an ester linkage at the a carbon atom, or norbornane lactone ester such as those shown in [formula 22] are particularly preferred in terms of industrial availability.

Structural Unit (a5)

There are no particular restrictions on the structural unit (a5), provided it is a different structural unit that cannot be classified as any of the above structural units (a1) through (a4). In other words, any structural unit that contains no acid dissociable, dissolution inhibiting groups, lactones, or hydroxyl groups is suitable. For example, structural units containing an aliphatic polycyclic group and derived from a (meth)acrylate ester are preferred. If this type of structural unit is used, then when the polymer is used within a positive resist composition, the composition exhibits superior resolution for isolated patterns through to semi-dense patterns (line and space patterns in which for a line width of 1, the space width is from 1.2 to 2), which is preferred.

Suitable examples of the aliphatic polycyclic group include solar groups to those listed in the above description for the structural unit (a2), and any of the multitude of materials conventionally used for ArF positive resist materials can be used.

From the viewpoint of industrial availability, one or more groups selected from amongst tricyclodecanyl groups, adamantyl groups, and tetracyclododecanyl groups is preferred.

Specific examples of the structural unit (a5) are shown below in [formula 25] through [formula 27]. 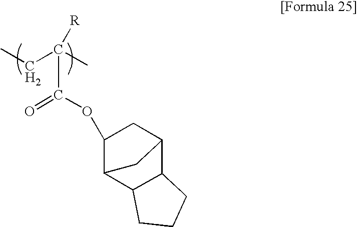
(wherein, R represents a hydrogen atom or a methyl group) 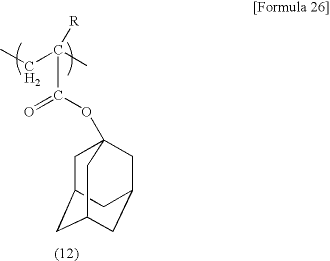
(wherein, R represents a hydrogen atom or a methyl group) 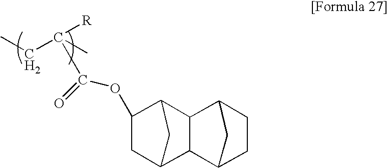
(wherein, R represents a hydrogen atom or a methyl group)

If the structural unit (as) accounts for I to 30 mol %, and preferably from 5 to 20 mol %, of the combined total of all the structural units that constitute the polymer, then the polymer exhibits superior resolution for isolated patterns through to semi-dense patterns, which is desirable.

In this polymer, the structural units other than the structural unit (a1) can be selected in accordance with factors such as the intended application. In particular, because the lactone functional group of the structural unit (a1) imparts favorable affinity with the alkali developing solution used during formation of a resist pattern, even a binary composition containing a structural unit (a1) and a structural unit (a2), but containing no structural unit (a3), enables favorable characteristics to be achieved as a positive resist composition. Tertiary compositions that also contain a structural unit (a3) enable even better characteristics to be obtained.

In the case of a binary polymer containing structural units (a1) and (a2), setting the quantity of the structural unit (a1) to 20 to 80 mol %, and preferably from 30 to 70 mol %, of the total of all the structural units, and the quantity of the structural unit (a2) to 20 to 80 mol %, and preferably from 30 to 70 mol %, enables a favorable pattern to be achieved, and is consequently preferred.

In addition, in the case of a tertiary system that also contains a structural unit (a3), setting the quantity of the structural unit (a1) to 20 to 60 mol %, and preferably from 30 to 50 mol %, of the total of all the structural units, the quantity of the structural unit (a2) to 20 to 60 mol %, and preferably from 30 to 50 mol %, of the total of all the structural units, and the quantity of the structural unit (a3) to 5 to 50 mol %, and preferably from 10 to 40 mol %, of the total of all the structural units, enables a superior balance to be achieved between the sensitivity, the resolution, and the resist pattern shape, and is consequently preferred.

Although there are no particular restrictions on the weight average molecular weight (the polystyrene equivalent value determined by gel permeation chromatography, this also applies to all subsequent values) of the polymer, the value is preferably within a range from 5,000 to 30,000, and even more preferably from 8,000 to 20,000. If the weight average molecular weight is larger than this range, then when used as a positive resist composition, the solubility of the polymer within the resist solvent deteriorates, whereas if the value is smaller than the above range, there is a danger of a deterioration in the cross-sectional shape of the resist pattern.

This polymer can be produced easily by a conventional radical polymerization or the like of the monomers [(meth)acrylates] corresponding with the aforementioned structural units (a1) through (a5), using a radical polymerization initiator such as azobisisobutyronitrile (AIBN).

The monomers corresponding with the structural units (a2) through (a5) are readily available as commercial products.

[Positive Resist Composition]

A preferred positive resist composition includes the resin component (A), an acid generator component (B) that generates acid on exposure, and an organic solvent (C).

Component (A)

As the component (A), any polymer that includes the aforementioned structural units (a1) and (a2) as essential components, and exhibits increased solubility in alkali under the action of acid can be used without any particular restrictions.

Component (B)

As the component (B), a compound appropriately selected from known materials used as acid generators in conventional chemically amplified resists can be used.

Examples of suitable compounds for this acid generator include onium salts such as diphenyliodonium trifluoromethanesulfonate, (4-methoxyphenyl)phenyliodonium trifluoromethanesulfonate, bis(p-tert-butylphenyl)iodonium trifluoromethanesulfonate, triphenylsulfonium trifluoromethanesulfonate, (4-methoxyphenyl)diphenylsulfonium trifluoromethanesulfonate, (4-methylphenyl)diphenylsulfonium nonafluorobutanesulfonate, (p-tert-butylphenyl)diphenylsulfonium trifluoromethanesulfonate, diphenyliodonium nonafluorobutanesulfonate, bis(p-tert-butylphenyl)iodonium nonafluorobutanesulfonate, and triphenylsulfonium nonafluorobutanesulfonate. Of these compounds, onium salts containing a fluorinated alkylsulfonate ion as the anion are preferred.

The component (B) can be used either alone, or in combinations of two or more different compounds.

The blend quantity of the component (B) is typically within a range from 0.5 to 30 parts by weight, and preferably from I to 20 parts by weight, per 100 parts by weight of the component (A). Ensuring the quantity is at least 0.5 parts by weight enables pattern formation to proceed satisfactorily, whereas restricting the quantity to no more than 30 parts by weight tends to enable a more uniform solution to be obtained, thus improving the storage stability.

Component (C)

A positive resist composition can be produced by dissolving the aforementioned component (A) and the component (B), together with any optional components described below, in an organic solvent component (C). There are no particular restrictions on the quantity of the component (C) used within the positive resist composition, which can be set to ensure a concentration that enables favorable application of the positive resist composition to the surface of a substrate or the like. For example, in a photoresist composition according to the present invention, the quantity of the organic solvent (C) is generally sufficient to produce a solid fraction concentration within the resist composition of 3 to 30% by weight, with the actual value set in accordance with the resist film thickness. The component (C) may be any solvent capable of dissolving the component (A) and the component (B) to generate a uniform solution, and one or more solvents selected from known materials used as the solvents for conventional chemically amplified resists can be used.

Specific examples of the solvent include ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; and esters such as methyl lactate, ethyl lactate, methyl acetate, ethyl acetate, butyl acetate, methyl pyruvate, ethyl pyruvate, methyl methoxypropionate, and ethyl ethoxypropionate. These organic solvents can be used alone, or as a mixed solvent of two or more different solvents.

In particular, mixed solvents of propylene glycol monomethyl ether acetate (PGMEA) and a polar solvent containing a hydroxyl group or a lactone such as propylene glycol monomethyl ether (PGME), ethyl lactate (EL) or γ-butyrolactone improve the storage stability of the positive resist composition, and are consequently preferred.

In those cases where EL is added, the weight ratio of PGMEA:EL is preferably within a range from 6:4 to 4:6.

In those cases where PGME is added, the weight ratio of PGMEA:PGME is typically within a range from 8:2 to 2:8, and preferably from 8:2 to 5:5.

Furthermore, mixed solvents containing at least one of PGMEA and EL, together with y-butyrolactone, are also preferred as the organic solvent (C). In such cases, the weight ratio of the former and latter components in the mixed solvent is preferably within a range from 70:30 to 95:5.

Component (D))

In the positive resist composition, in order to improve properties such as the resist pattern shape and the long term stability (post exposure stability of the latent image formed by the pattern-wise exposure of the resist layer), an amine (D), and preferably a secondary lower aliphatic amine or a tertiary lower aliphatic amine, can also be added as an optional component (D).

Here, a lower aliphatic amine refers to an alkyl or alkyl alcohol amine of no more than 5 carbon atoms, and examples of these secondary and tertiary amines include trimethylamine, diethylamine, triethylamine, di-n-propylamine, tri-n-propylamine, tripentylamine, diethanolamine and triethanolamine, and alkanolamines such as triethanolamine are particularly preferred.

These may be used alone, or in combinations of two or more different compounds.

This amine is typically added in a quantity within a range from 0.01 to 2 parts by weight per 100 parts by weight of the component (A).

(E) Organic Carboxylic Acid, or Phosphorus Oxo Acid or Derivative thereof

In the positive resist composition, in order to prevent any deterioration in sensitivity caused by the addition of the aforementioned component (D), and improve the resist pattern shape and the post exposure stability of the latent image formed by the pattern-wise exposure of the resist layer, an organic carboxylic acid, or a phosphorus oxo acid or derivative thereof can also be added as another optional component (E). The component (D) and the component (E) can be used in combination, or either one may also be used alone.

Examples of suitable organic carboxylic acids include malonic acid, citric acid, malic acid, succinic acid, benzoic acid, and salicylic acid.

Examples of suitable phosphorus oxo acids or derivatives thereof include phosphoric acid or derivatives thereof such as esters, including phosphoric acid, di-n-butyl phosphate and diphenyl phosphate; phosphonic acid or derivatives thereof such as esters, including phosphonic acid, dimethyl phosphonate, di-n-butyl phosphonate, phenylphosphonic acid, diphenyl phosphonate, and dibenzyl phosphonate; and phosphinic acid or derivatives thereof such as esters, including phosphinic acid and phenylphosphinic acid, and of these, phosphonic acid is particularly preferred.

The component (E) is typically used in a quantity within a range from 0.01 to 5 parts by weight per 100 parts by weight of the component (A).

Miscible additives can also be added to the positive resist composition according to need, including additive resins for improving the properties of the resist film, surfactants for improving the ease of application, dissolution inhibitors, plasticizers, stabilizers, colorants and halation prevention agents.

This positive resist composition can be used as a positive resist composition for KrF excimer lasers and shorter wavelength sources. The composition exhibits excellent transparency relative to wavelengths of 200 nm or shorter, and is consequently very useful as the positive resist composition for an ArF excimer laser, but it is also useful as a resist for even shorter wavelength sources such as F₂ lasers, and other radiation such as EUV (extreme ultraviolet), VUV (vacuum ultraviolet), electron beams, X-rays, and soft X-rays.

This positive resist composition suppresses the occurrence of surface roughness such as line and roughness that occurs within a resist pattern, either following etching or following developing, or preferably following both processes. The post-etching surface roughness suppression effect is particularly powerful.

Furthermore, this positive resist composition also exhibits favorable resolution. In recent years, the design rules prescribed for semiconductor element production have continued to become more stringent and a resolution of no more than 150 nm, and in the vicinity of 100 nm is now required, and this positive resist composition can also be used for such applications.

Furthermore, a favorably broad depth of focus can also be achieved.

[Method of Forming Resist Pattern]

A method of forming a resist pattern according to the present invention can be conducted, for example, in the manner described below.

Namely, a positive resist composition described above is first applied to the surface of a substrate such as a silicon wafer using a spinner or the like, and a prebake is conducted under temperature conditions of 80 to 150° C. for 40 to 120 seconds, and preferably for 60 to 90 seconds. Following selective exposure of the applied resist with an ArF exposure apparatus or the like, by irradiating ArF excimer laser light through a desired mask pattern, PEB (post exposure baking) is conducted under temperature conditions of 80 to 150° C. for 40 to 120 seconds, and preferably for 60 to 90 seconds. Subsequently, developing is conducted using an alkali developing solution such as a 0.1 to 100% by weight aqueous solution of tetrainethylammonium hydroxide. In this manner, a resist pattern that is faithful to the mask pattern can be obtained.

An organic or inorganic anti-reflective film may also be provided between the substrate and the applied layer of the resist composition.

### EXAMPLES

As follows is a more detailed description of the present invention, based on a series of examples.

### Reference Example 1

A lactone compound (lactone acrylate) represented by [formula 28] shown below was produced.

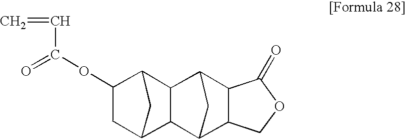

### (1) Synthesis of tetracyclo[6.2.1.1^{3,6}.0^{2,7})dodeca-9-ene-4,5-dicarboxylic anhydride

A 200 ml induction stirring-type autoclave was charged with 44.9 g (0.340 mols) of dicyclopentadiene, 33.3 g (0.340 mols) of maleic anhydride, and 50 ml of xylene, the temperature was raised to 220° C., and the reaction was allowed to proceed at that temperature for 3 hours. Following cooling, the reaction solution was removed and distilled, and the fraction collected at 165 to 175° C. at 0.1 mmHg yielded 30.2 g of tetracyclo[6.2.1.1^{3,6}.0^{2,7}]dodeca-9-ene-4,5dicarboxylic anhydride.

### (2) Synthesis of 5-oxo-oxapentacyclo[9.2.1.1^{3,9}.0^{2,10}.0^{4,8}]pentadecane-12-ene

To a suspension of 4.72 g (0. 124 mols) of sodium borohydride in 130 mol of tetrahydrofuran was added dropwise, at room temperature, a solution containing 28.3 g (0.122 mols) of the tetracyclo[6.2.1.1^{3,6}.0^{2,7}]dodeca-9-ene-4,5-dicarboxylic anhydride prepared above in (1) dissolved in 70 ml of tetrahydrofuran. Following completion of the dropwise addition, the reaction mixture was stirred for a further one hour at room temperature. The reaction mixture was then cooled in an ice bath, and hydrolysis was conducted by adding 125 ml of 1N hydrochloric acid solution. The phases were then separated to isolate the organic phase, 50 ml of toluene was added, and the resulting solution was washed three times with 30 ml samples of water. The organic phase was then dried over anhydrous magnesium sulfate, and subsequently distilled, yielding 14.8 g of the lactone as the fraction collected at 172 to 175° C. at 0.1 mmHg.

### (3) Synthesis of 5-oxo4oxapentacyclo[9.2.1^{1,11}.0^{3,9}.0^{2,10}.0^{4,8}]pentadeca-13-yl acrylate

A three-neck flask was charged with 11.3 g (0.0525 mols) of the lactone prepared in (2) above, 100 ml of water, and 150 ml of diethylene glycol dimethyl ether, and 5.15 g (0.0525 mols) of concentrated sulfuric acid was then added. The flask was heated to 100° C., and the reaction was allowed to proceed at that temperature for 8 hours. Following completion of the reaction, the reaction mixture was neutralized with a saturated aqueous solution of sodium carbonate, and was then extracted with 400 ml of ethyl acetate. The organic phase was separated and dried over anhydrous magnesium sulfate. The magnesium sulfate was then removed by filtration, and the solvent was removed by distillation, yielding 9.84 g (0.042 mols) of a pale yellow colored viscous liquid. This liquid was dissolved in 40 ml of methylene chloride, the solution was cooled in an ice bath, and 4.18 g (0.0462 mols) of acryloyl chloride, and then 5.09 g (0.0504 mols) of triethylamine were added dropwise to the solution. Following reaction at room temperature for 12 hours, normal post-reaction treatment was conducted, and the resulting product was isolated by silica gel chromatography, yielding 6.05 g of a pale yellow colored viscous liquid. The results of ¹H-NMR spectroscopy and mass spectrometry measurements confirmed the product as 5-ox&&oxapentacyclo[9.2.1^{1,11}.1^{3,9}.0^{2,10}.0^{4,8}]pentadeca.13-yl acrylate.

¹H-NMR (CHCl₃d): 0.95 to 1.97 (m, 7H), 2.15 to 2.70 (m, 7H), 4.20 to 4.50 (m, 2H), 4.55 to 4.67 (m, 1H), 5.80 (d, 1H), 6.06 (dd, 1H), 6.35 (d, 1H)

Mass spectrometry: M⁺=288

### Example 1

The components (A) to (D) described below were mixed together and dissolved to prepare a positive resist composition,

Component (A): 100 parts by weight of a copolymer (weight average molecular weight: 10,000, Tg: 165° C.) produced by copolymerization of the monomers below:

2-ethyl-2-adamantyl acrylate: 50 mol % (the monomer that corresponds with the structural unit (a2), and generates a structural unit of the formula 8 wherein R is a hydrogen atom and R¹ is an ethyl group), and

the lactone acrylate prepared in the reference example 1; 50 mol % (the monomer that corresponds with the structural unit (a1)).

Component (B): 2.5 parts by weight of triphenylsulfonium nonafluorobutanesulfonate.

Component (D): 0.1 parts by weight of triethanolamine.

Component (C): a mixed solvent containing 450 parts by weight of PGMEA and 300 parts by weight of EL.

Subsequently, this positive type resist composition was applied to the surface of a silicon wafer using a spinner, prebaked (PAB treatment) for 60 seconds at 130° C. on a hotplate, and then dried to form a resist layer with a film thickness of 350 mm.

This film was then selectively irradiated with an ArF excimer laser (193 nm) through a mask pattern, using an ArF exposure apparatus (micro Step, manufactured by ISI Corporation, NA (numerical aperture)=0.60, σ=0.75).

The film was then subjected to PEB treatment at 120° C. for 60 seconds, subsequently subjected to puddle development for 30 seconds at 23° C. in a 2.38% by weight aqueous solution of tetramethylammonium hydroxide, and was then washed for 20 seconds with water, and dried.

As a result, a 130 nm resist line pattern (1:1) was formed with good shape. The sensitivity was 30 mJ/cm².

The depth of focus for the 130 nm line and space pattern (1:1) was 400 nm.

Furthermore, when the 3σ value, which is a measure of the line edge roughness of the line and space pattern, was determined, the result was 5.4 nm.

The 3σ value is determined by measuring the resist pattern width of the sample at 32 positions using a measuring SEM (S-9220, a brand name, manufactured by Hitachi, Ltd.), and calculating the value of 3 times the standard deviation (3σ) from these measurement results. The smaller this 3σ value is, the lower the level of roughness, indicating a resist pattern with a uniform width.

Furthermore, in order to evaluate the surface roughness following etching, an unpatterned resist film was prepared (by applying the positive type resist composition to a substrate, and conducting exposure without using a mask pattern), and subsequently etched under the following conditions.

Etching gas: a mixed gas comprising tetrafluoromethane: 30 sccm, trifluoromethane: 30 sccm, and helium: 100 sccm.

Pressure: 0.3 Torr.

RF (Ratio frequency): frequency: 400 kHz, output: 600 W.

Temperature: 20° C., time: 2 minutes.

Etching apparatus: TCE-7612X (a brand name, manufactured by Tokyo Ohka Kogyo Co., Ltd.).

The reason for performing the evaluation using an unpatterned resist film is that this enables surface roughness to be measured more easily.

The surface following this etching was numericalized with an AFM (Atomic Force Microscope), and when the Rms value (root mean square surface roughness), which is a value representing the surface roughness, was then determined, the result was 0.9 nm

### Example 2

With the exception of altering the component (A) to a copolymer that also included a structural unit (a3), a positive resist composition was produced and evaluated in the same manner as the example 1.

In this example, the component (A) used 100 parts by weight of a copolymer (weight average molecular weight: 10,000, Tg: 162° C.) produced by copolymerization of the monomers below:

2-ethyl-2-adamantyl acrylate: 40 mol % (corresponds with the structural unit (a2),

the lactone acrylate represented by the aforementioned [formula 28]: 40 mol % (corresponds with the structural unit (a1), and

3-hydroxy-1-adamantyl acrylate: 20 mol % (the monomer that corresponds with the structural unit (a3), and generates a structural unit of the [formula 11] wherein R is a hydrogen atom).

As a result, a 130 nm resist line pattern (1:1) was formed with good shape, The sensitivity was 28 mJ/cm².

The depth of focus for the 130 nm line and space pattern (1:1) was 500 in.

Furthermore, when the line edge roughness 3a was determined following developing, the result was 5,4 nm.

The surface roughness Rms measured in the same manner as the example 1 was 0.9 nm.

### Comparative Example 1

With the exceptions of altering the component (A) from the example 2 by replacing the monomer represented by the [formula 28] with α-gamma-butyrolactone methacrylate (the monomer of the [formula 24] wherein R is a methyl group), and replacing the 2-ethyl-2-adamantly) acrylate as the structural unit (a2) with 2-methyl-2-adamantyl methacrylate (the monomer that generates a structural unit of the [formula 8] wherein R is a methyl group and R¹ is a methyl group), a positive resist composition was produced and evaluated in the same manner as the example 2.

As a result, the 130 nm resist line pattern (1:1) exhibited a slightly tapered shape. The depth of focus for the 130 nm line and space pattern (1:1) was 300 nm.

Furthermore, the surface roughness Rms measured in the same manner as the example 1 was 11.5 nm.

### Comparative Example 2

With the exceptions of altering the component (A) from the example 2 by replacing the monomer represented by the [formula 28] with α-gamma-butyrolactone methacrylate, replacing the 2-ethyl-2-adamantyl acrylate as the structural unit (a2) with 2-ethyl-2-adamantyl methacrylate (the monomer that generates a structural unit of the [formula 8] wherein R is a methyl group and R¹ is an ethyl group), and replacing the 3-hydroxy-1-adamantyl acrylate as the structural unit (a3) with 3-hydroxy-1-adamantyl methacrylate (the monomer that generates a structural unit of the (formula 11] wherein R is a methyl group), as well as altering the PAB treatment and PEB treatment conditions to 60 seconds at 120° C., and 60 seconds at 110° C. respectively, a positive resist composition was produced and evaluated in the same manner as the example 2.

As a result, the 130 nm resist line pattern (1:1) exhibited a slightly tapered shape. The depth of focus for the 130 nm line and space pattern (1:1) was 200 nm. Furthermore, when the line edge roughness 3σ was determined following developing, the result was 7.0 nm.

Furthermore, the surface roughness Rms measured in the same manner as the example 1 was 13.5 nm.

From these results it is clear that in the examples, the Rms value is small in both cases, confirming that the occurrence of surface roughness following etching can be suppressed. Furthermore, the LER value also tends to be comparatively smaller, indicating that the surface roughness of the resist pattern following alkali developing also tends to be suppressed.

In addition to these characteristics, it is also clear that the resist pattern shapes are favorable, the resolution is also favorable, and the depth of focus (DOF) is large.

Furthermore, if the structural units contained within the component (A) include a large quantity of acrylate structural units, then generally the post-etching surface roughness suppression effect tends to increase, although as the quantity of acrylate structural units increases, the glass transition temperature of the component (A) tends to decrease. However,.comparing the example 2 and the comparative example 2, it is evident that even though the example 2 includes a larger quantity of acrylate units than the comparative example 2, the heating temperatures for the PAB treatment and PEB treatment were able to be set to higher values. The reason for this observation is thought to be due to the fact that by using the monomer represented by the aforementioned [formula 28], the glass transition temperature of the component (A) increases, meaning the heating temperatures can be set to high values even though the acrylate structural unit content is high. Accordingly, the surface roughness following etching can be suppressed, and the heat treatment temperatures can be increased, enabling an improvement in sensitivity to be achieved.

### EFFECTS OF THE INVENTION

As described above, according to the present invention, the occurrence of surface roughness that occurs within a resist pattern is suppressed, either following etching or following developing, or preferably following both processes.

### INDUSTRIAL APPLICABILITY

The present invention provides a polymer that can be used favorably in a positive resist composition, a positive resist composition that uses the polymer, and a method of forming a resist pattern that uses the positive resist composition, and consequently exhibits good industrial applicability.

1. A polymer comprising a structural unit (a1) containing a lactone, as represented by a general formula shown below: 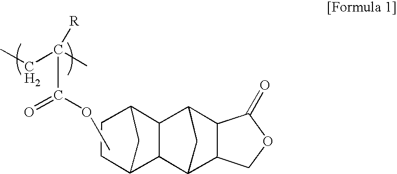
(wherein, R represents a hydrogen atom or a methyl group).

2. A polymer according to claim 1, wherein said structural unit (a1) accounts for 20 to 60 mol % of a combined total of all structural units.

3. A polymer according to claim 1, further comprising a structural unit (a2), which contains an acid dissociable, dissolution inhibiting group, and is derived from a (meth)acrylate ester.

4. A polymer according to claim 3, wherein said structural unit (a2) is at least one unit selected from a group consisting of general formulas (I), (II), and (III) shown below: 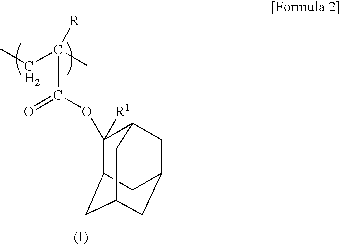
(wherein, R represents a hydrogen atom or a methyl group, and R¹ represents a lower alkyl group) 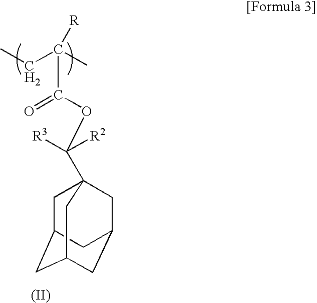
(wherein, R represents a hydrogen atom or a methyl group, and R² and R³ each represent, independently, a lower alkyl group) 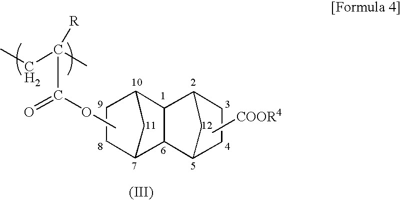
(wherein, R represents a hydrogen atom or a methyl group, and R⁴ represents a tertiary alkyl group).

5. A polymer according to claim 3, wherein said structural unit (a2) accounts for 20 to 60 mol% of a combined total of all structural units.

6. A polymer according to claim 1, forther comprising a structural unit (a3), which contains a hydroxyl group, and is derived from a (meth)acrylate ester.

7. A polymer according to claim 6, wherein said structural unit (a3) is one or two units selected from a group consisting of general formulas (IV) and (V) shown below: 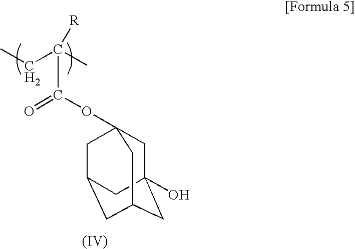
(wherein, R represents a hydrogen atom or a methyl group) 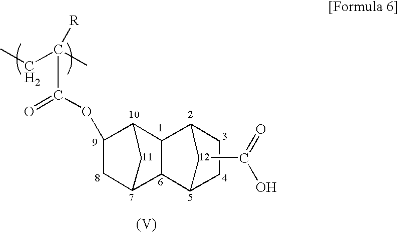
(wherein, R represents a hydrogen atom or a methyl group).

8. A polymer according to claim 6, wherein said structural unit (a3) accounts for 5 to 50 mol % of a combined total of all smctural units.

9. A polymer according to claim 1, wherein said polymer is a positive resist composition, and exhibits increased alkali solubility under action of acid.

10. A positive resist composition, comprising a resin component (A), an acid generator component (B) that generates acid on exposure, and an organic solvent (C), wherein
said component (A) comprises a polymer according to claim 9.

11. A positive resist composition according to claim 10, wherein said component (B) is an onium salt with a fluorinated alkylsulfonate ion as an anion.

12. A positive resist composition according to claim 10, wherein said component (C) is a mixed solvent of propylene glycol monomethyl ether acetate and a polar solvent.

13. A positive resist composition according to claim 12, wherein said polar solvent is ethyl lactate.

14. A positive resist composition according to claim 10 further comprising a secondary or tertiary lower aliphatic amine CD).

15. A method of forming a resist pattern comprising the steps of applying a positive resist composition according to claim 10 to a substrate, conducting a prebake, performing selective exposure, conducting PEB (post exposure baking), and performing alkali developing to form a resist pattern.
